(19) United States
(12) Patent Application Publication
(10) Pub. No.: US 2021/0014426 A1
(43) Pub. Date: Jan. 14, 2021

(54) PROJECTION LIGHT WITH SYNCHRONOUS TRACKING FUNCTION

(71) Applicant: Mao-Shen WANG, New Taipei City (TW)

(72) Inventor: Mao-Shen WANG, New Taipei City (TW)

(21) Appl. No.: 16/505,762

(22) Filed: Jul. 9, 2019

(51) Int. Cl. H04N 5/232; G03B 21/14; H04N 5/225

(52) U.S. Cl. CPC H04N 5/23299; H04N 5/2256; G03B 21/145; G03B 21/142

(57) ABSTRACT

A projection light with synchronous tracking function includes a main body, a lighting module mounted in the main body, a signal receiving module disposed on the main body and a signal transmission module for a user (or a mobile article) to wear. The main body defines a chamber for receiving a transmission mechanism. The signal transmission module serves to output a signal to the signal receiving module. After receiving the signal output from the signal transmission module, the signal receiving module controls the transmission mechanism to drive the main body (and the lighting module) to longitudinally and/or transversely rotate so as to synchronously track the direction and position of the user (or the mobile article).

### BACKGROUND OF THE INVENTION

### 1. Field of the Invention

The present invention relates generally to a projection light, and more particularly to a projection light with synchronous tracking function. The projection light is equipped with a signal receiving module for receiving the signal transmitted from a signal transmission module. After receiving the signal transmitted from the signal transmission module, the signal receiving module drives the projection light to longitudinally and/or transversely rotate so as to achieve synchronous tracking effect.

### 2. Description of the Related Art

A conventional bulb or light-emitting diode (LED) is used as a light source or illumination device. The bulb or LED is widely used in many sites or environments. For example, the bulb or LED can project light onto a product in an exhibition site.

The lighting device or illumination device pertains to a mature technical field. Various improvements of the respective structures or designs of the lighting device or illumination device have been disclosed.

The lighting device or illumination device has some shortcomings in structure and application. For example, the conventional lighting device or illumination device in generally in a fixed state. This affects the illumination range or direction of the lighting device. In order to improve this shortcoming, a lighting device structure with adjustable or enlarged illumination angle has been disclosed.

However, as well known by those who are skilled in this field, when it is desired to project light onto a different position, in practice, an operator must operate the lighting device to direct the lighting device in a predetermined angle. Such operation is troublesome and leads to increase of labor cost. This is not what we expect.

To speak representatively, the above reveals some shortcomings and problems of the conventional lighting device or illumination device in structure, application and practical use. In case the structure cooperation of the lighting device or illumination device is redesigned to be different from the conventional lighting device or illumination device, the use form of the lighting device or illumination device can be changed to practically improve the application thereof. For example, the lighting device or illumination device can automatically and/or movably project light onto a specific person/product in many special sites or environments. Also, the synchronous tracking effect of the lighting device or illumination device can be enhanced. In this case, the shortcomings that the operation is troublesome and the labor cost is increased are as improved as possible.

All these issues are not specifically taught or disclosed in the above references.

### SUMMARY OF THE INVENTION

It is therefore a primary object of the present invention to provide a projection light with synchronous tracking function. The projection light includes a main body, a lighting module mounted in the main body and a signal receiving module disposed on the main body, (such as a photosensor). The main body defines a chamber for receiving a transmission mechanism. The projection light further includes a signal transmission module for a user (or a mobile article) to wear, (such as a light transmission module). The signal transmission module serves to output a signal to the signal receiving module. After receiving the signal output from the signal transmission module, the signal receiving module controls the transmission mechanism to drive the main body (and the lighting module) to longitudinally and/or transversely rotate so as to synchronously track the direction and position of the user (or the mobile article).

In the above projection light with synchronous tracking function, the signal transmission module is disposed on a wearing body (or a strap body) for a user (or a mobile article) to wear. The signal transmission module has annularly arranged signal transmission components. Accordingly, the signal transmission module can 360-degree output signal to the surrounding of the user (or the mobile article).

In the above projection light with synchronous tracking function, the signal receiving module includes a receiver (or a camera head) disposed on the main body and connected to a central processor. The central processor is connected to the lighting module and the transmission mechanism for controlling the same to drive the main body (and the lighting module) to longitudinally and/or transversely rotate.

The present invention can be best understood through the following description and accompanying drawings, wherein:

### BRIEF DESCRIPTION OF THE DRAWINGS

FIG. 1 is a perspective view of the projection light with synchronous tracking function of the present invention, showing the structures of the main body, the lighting module, the signal receiving module and the signal transmission module;

FIG. 2 is a block diagram of the projection light with synchronous tracking function of the present invention;

FIG. 3 is a schematic diagram showing the application of the projection light with synchronous tracking function of the present invention; and

FIG. 4 is another schematic diagram showing the application of the projection light with synchronous tracking function of the present invention.

### DETAILED DESCRIPTION OF THE PREFERRED EMBODIMENTS

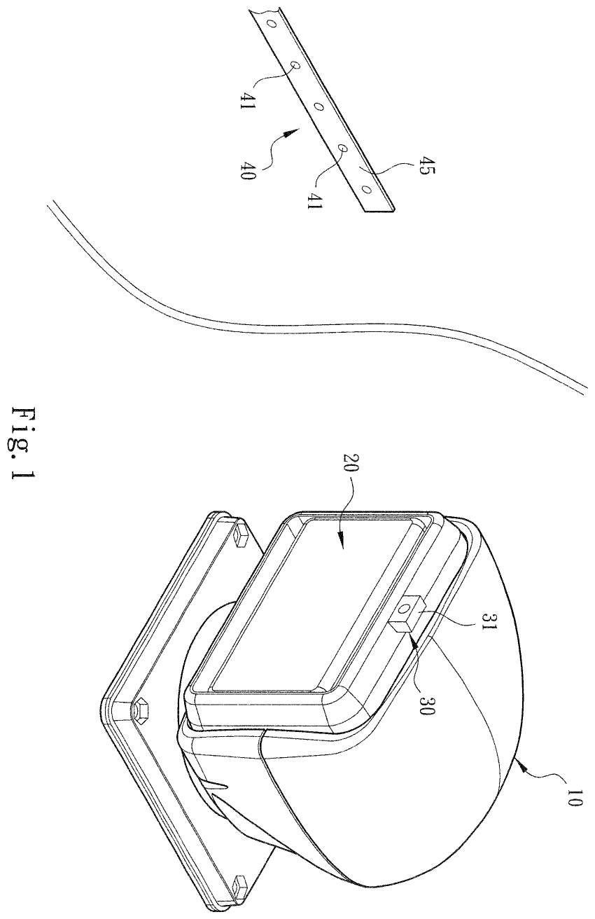

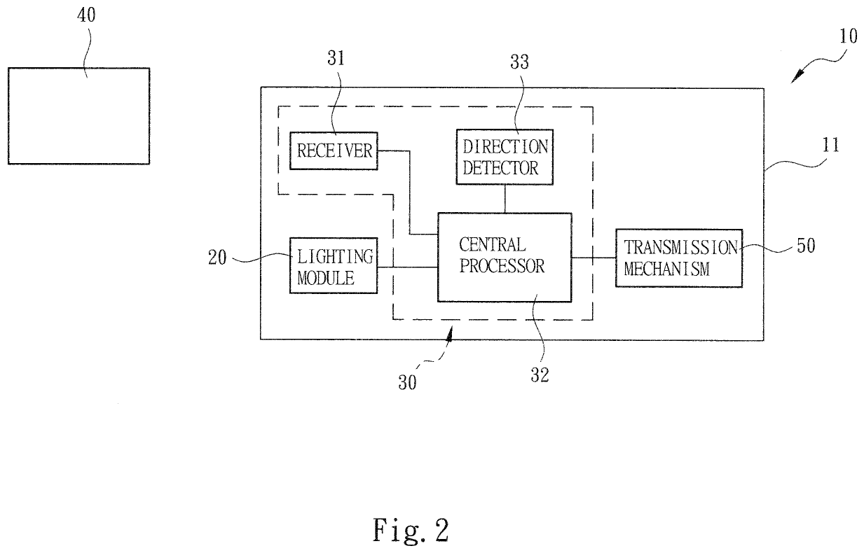

Please refer to FIGS. 1 and 2. The projection light with synchronous tracking function of the present invention includes an assembly of a main body 10, a lighting module 20, a signal receiving module 30 (such as a photosensor) and a signal transmission module 40 (such as a light transmission module).

As shown in the drawings, the main body 10 is a case structure in which the lighting module 20 is mounted. The main body 10 defines a chamber 11 for receiving the signal receiving module 30 and a transmission mechanism 50. The signal transmission module 40 is disposed on a wearing body 45 (or a strap body, a wearable body or the like). The signal transmission module 40 has annularly arranged signal transmission components 41 (such as light-emitting components) for a user (or a mobile article) to wear. Accordingly, the signal transmission module 40 can 360-degree output signal to the surrounding of the user (or the mobile article). The signal can be infrared signal.

In this embodiment, the signal receiving module 30 includes a receiver 31 (infrared sensor capable of receiving infrared signal). The receiver 31 can be a photo-receiver or a camera head structure disposed on the main body 10. In addition, a central processor 32 is disposed in the signal receiving module 30 and connected to the receiver 31. The central processor 32 is connected to the transmission mechanism 50 for controlling the same to drive the main body 10 (and the lighting module 20) to longitudinally and/or transversely rotate.

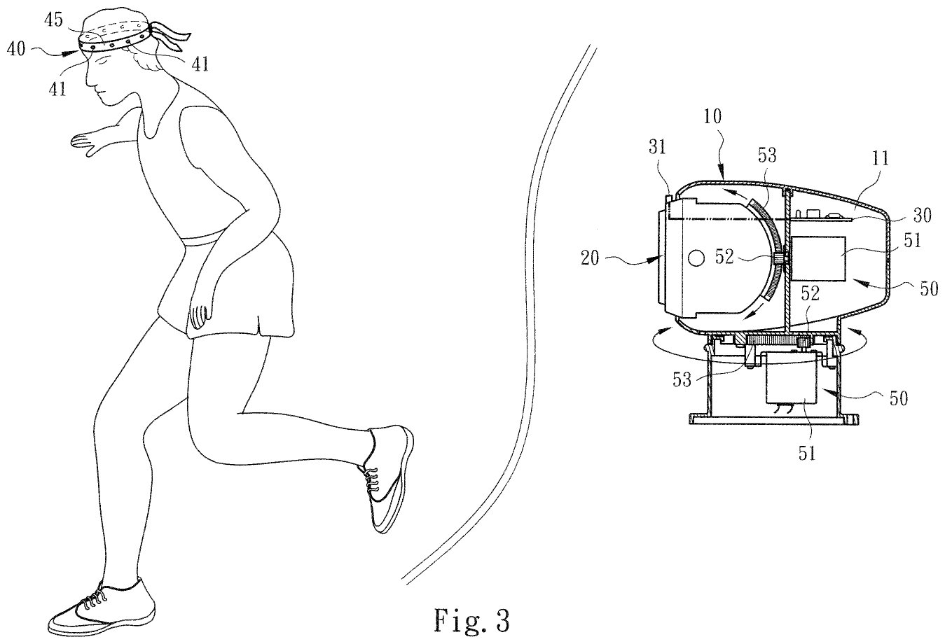

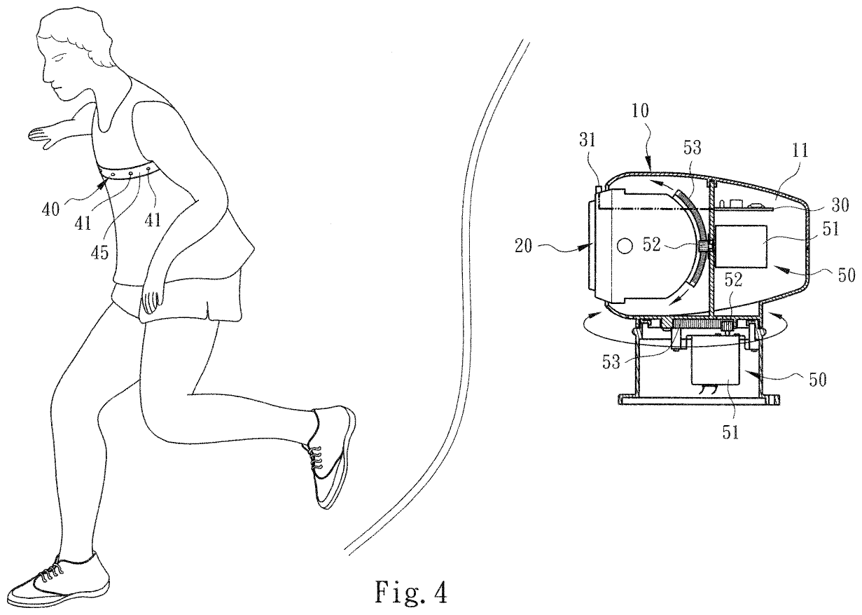

As shown in FIGS. 3 and 4, the transmission mechanism 50 is disposed in the chamber 11 defined by the main body 10. The transmission mechanism 50 includes a motor 51, a rotary shaft 52 and a rack 53 engaged with the rotary shaft 52. In the case that two transmission mechanisms 50 are used, the main body 10 (and the lighting module 20) can be driven to longitudinally and/or transversely rotate. This pertains to prior arts and thus will not be further described hereinafter.

Please refer to FIGS. 2, 3 and 4. In a preferred embodiment, the central processor 32 of the signal receiving module 30 is provided with or electrically connected with a direction detector 33. The direction detector 33 serves to help the signal receiving module 30 to detect the direction and position of the signal transmission module 40 worn on the user (or the mobile article). Accordingly, the central processor 32 can control the transmission mechanism 50 to drive the main body 10 and the lighting module 20 to longitudinally and/or transversely rotate. Therefore, the main body 10 and the lighting module 20 can automatically move in a direction to the position of the user so as to synchronously track the user (or the mobile article) to project light thereon.

To speak representatively, in comparison with the conventional projection light, the projection light with synchronous tracking function of the present invention has the following advantages:
1. The structures and connection relationship of the main body 10, the lighting module 20, the signal transmission module 40 and the signal receiving module 30 have been redesigned. For example, the receiver 31 of the signal receiving module 30 is electrically connected to the central processor 32. After the receiver 31 receives the signal output from the signal transmission module 40, the signal receiving module 30 (or the central processor 32) controls the transmission mechanism 50 to drive the main body 10 and the lighting module 20 to automatically synchronously track the user (or the mobile article). The present invention is obviously different from the conventional projection light in use form.
2. Especially, the main body 10, the lighting module 20, the signal transmission module 40 and the signal receiving module 30 are also applicable to a stage performer and/or a mobile article to project light onto the stage performer and/or the mobile article or film the same. According to the conventional projection light, when it is desired to project light onto a predetermined position by a specific angle, an operator must manually move the projection light to direct the projection light in a predetermined angle. Such operation is troublesome and leads to increase of labor cost. The present invention obviously improves the shortcoming of the conventional projection light.

In conclusion, the projection light with synchronous tracking function of the present invention is different from the conventional projection light in space form and is advantageous over the conventional projection light. The projection light with synchronous tracking function of the present invention is greatly advanced and inventive.

The above embodiments are only used to illustrate the present invention, not intended to limit the scope thereof. Many modifications of the above embodiments can be made without departing from the spirit of the present invention.

What is claimed is:

1. A projection light with synchronous tracking function, comprising an assembly of a main body 10, a lighting module 20, a signal receiving module 30 and a signal transmission module 40, the main body 10 being a case structure in which the lighting module 20 is mounted, the main body 10 defining a chamber 11 for receiving the signal receiving module 30 and a transmission mechanism 50, the signal receiving module 30 serving to receive the signal output from the signal transmission module 40 so as to control the transmission mechanism 50 to drive the main body 10 and the lighting module 20, whereby the main body 10 and the lighting module 20 can automatically synchronously track the direction and position of the signal transmission module 40.

2. The projection light with synchronous tracking function as claimed in claim 1, wherein the main body 10 is a case structure in which the lighting module 20 is mounted, the signal transmission module 40 having signal transmission components 41, which are annularly arranged on a wearing body 45, whereby the signal transmission module 40 can 360-degree output signal.

3. The projection light with synchronous tracking function as claimed in claim 1, wherein the signal transmission module 40 is disposed on at least one of a user and a mobile article, the signal transmission module 40 being a light transmission module, the signal output from the signal transmission module 40 being infrared signal.

4. The projection light with synchronous tracking function as claimed in claim 2, wherein the signal transmission module 40 is disposed on at least one of a user and a mobile article, the signal transmission module 40 being a light transmission module, the signal output from the signal transmission module 40 being infrared signal.

5. The projection light with synchronous tracking function as claimed in claim 1, wherein the signal receiving module 30 includes a receiver 31 and a central processor 32 is disposed in the signal receiving module 30 and connected to the receiver 31, the central processor 32 being connected to the transmission mechanism 50 for controlling the transmission mechanism 50 to drive the main body 10 and the lighting module 20 to longitudinally and transversely rotate.

6. The projection light with synchronous tracking function as claimed in claim 2, wherein the signal receiving module 30 includes a receiver 31 and a central processor 32 is disposed in the signal receiving module 30 and connected to the receiver 31, the central processor 32 being connected to the transmission mechanism 50 for controlling the transmission mechanism 50 to drive the main body 10 and the lighting module 20 to longitudinally and transversely rotate.

7. The projection light with synchronous tracking function as claimed in claim 3, wherein the signal receiving module 30 includes a receiver 31 and a central processor 32 is disposed in the signal receiving module 30 and connected to the receiver 31, the central processor 32 being connected to the transmission mechanism 50 for controlling the transmission mechanism 50 to drive the main body 10 and the lighting module 20 to longitudinally and transversely rotate.

8. The projection light with synchronous tracking function as claimed in claim 4, wherein the signal receiving module 30 includes a receiver 31 and a central processor 32 is disposed in the signal receiving module 30 and connected to the receiver 31, the central processor 32 being connected to the transmission mechanism 50 for controlling the transmission mechanism 50 to drive the main body 10 and the lighting module 20 to longitudinally and transversely rotate.

9. The projection light with synchronous tracking function as claimed in claim 5, wherein the receiver 31 can be a camera head structure disposed on the main body 10.

10. The projection light with synchronous tracking function as claimed in claim 7, wherein the receiver 31 can be a camera head structure disposed on the main body 10.

11. The projection light with synchronous tracking function as claimed in claim 5, wherein the central processor 32 of the signal receiving module 30 is provided with a direction detector 33.

12. The projection light with synchronous tracking function as claimed in claim 7, wherein the central processor 32 of the signal receiving module 30 is provided with a direction detector 33.

13. The projection light with synchronous tracking function as claimed in claim 9, wherein the central processor 32 of the signal receiving module 30 is provided with a direction detector 33.

14. The projection light with synchronous tracking function as claimed in claim 1, wherein the transmission mechanism 50 includes a motor 51, a rotary shaft 52 and a rack 53 engaged with the rotary shaft 52.

15. The projection light with synchronous tracking function as claimed in claim 2, wherein the transmission mechanism 50 includes a motor 51, a rotary shaft 52 and a rack 53 engaged with the rotary shaft 52.

16. The projection light with synchronous tracking function as claimed in claim 5, wherein the transmission mechanism 50 includes a motor 51, a rotary shaft 52 and a rack 53 engaged with the rotary shaft 52.

17. The projection light with synchronous tracking function as claimed in claim 9, wherein the transmission mechanism 50 includes a motor 51, a rotary shaft 52 and a rack 53 engaged with the rotary shaft 52.

18. The projection light with synchronous tracking function as claimed in claim 11, wherein the transmission mechanism 50 includes a motor 51, a rotary shaft 52 and a rack 53 engaged with the rotary shaft 52.

19. The projection light with synchronous tracking function as claimed in claim 1, wherein the signal receiving module 30 is a photosensor.

20. The projection light with synchronous tracking function as claimed in claim 2, wherein the signal receiving module 30 is a photosensor.
